(19) United States
(12) Patent Application Publication
(10) Pub. No.: US 2019/0186649 A1
(43) Pub. Date: Jun. 20, 2019

(54) Liquid Flow Control Attachment with Wireless Connection

(71) Applicant: William J. Warren, Frisco, TX (US)

(72) Inventor: William J. Warren, Frisco, TX (US)

(21) Appl. No.: 15/970,768

(22) Filed: May 3, 2018

Related U.S. Application Data
(60) Provisional application No. 62/599,388, filed on Dec. 15, 2017.
(60) Provisional application No. 62/647,646, filed on Mar. 24, 2018.

(51) Int. Cl. F16K 31/04; G05D 7/06

(52) U.S. Cl. CPC F16K 31/046; B67D 3/0077; G05D 7/0605

(57) ABSTRACT

A liquid flow control attachment with wireless connection is described herein. An outer ring can be attached to a terminal end of a liquid dispensing unit, such as a hose, faucet, or pipe. The outer ring has an antenna and circuitry to enable wireless communications. A remote user can control a flow of liquid from the liquid dispensing unit, through the liquid flow control attachment, via wireless communications. An inner connector may also be used in conjunction with the outer ring to provide effective flow control. The inner connector may be wirelessly controlled such that it can be opened or controlled by a remote user, to control a flow of liquid from the liquid dispensing unit.

### CROSS-REFERENCE TO RELATED APPLICATIONS

The present application claims the priority benefit of U.S. Provisional Application No. 62/599,388 filed on Dec. 15, 2017, and also claims the priority benefit of U.S. Provisional Application No. 62/647,646 filed on Mar. 24, 2018. The above-referenced applications are hereby incorporated by reference herein in their entirety for all purposes, including any references cited therein.

### FIELD

The present technology pertains to a computer programmable liquid flow control attachment to a liquid dispensing unit, and in particular a liquid flow control attachment with wireless communication capability.

### SUMMARY

Various embodiments of the present disclosure are directed to a liquid flow control attachment with wireless connection. One exemplary embodiment of a liquid flow control attachment apparatus comprises an outer ring configured to attach to a terminal end of a liquid dispensing unit in a watertight manner, the outer ring further comprising: an outer ring main body that is substantially cylindrical in shape; an antenna coupled to the outer ring main body, the antenna configured to transmit and receive wireless communications to or from a computing unit; and a housing unit coupled to the outer ring main body, the housing unit comprising: a microprocessor operating in conjunction with the antenna to transmit and receive the wireless communications to or from the computing unit; a computing memory operating in conjunction with the microprocessor; and an electrical connector interface for coupling to a power source.

Another exemplary embodiment of a liquid flow control apparatus comprises an outer ring configured to attach to a terminal end of the liquid dispensing unit in a watertight manner, the outer ring further comprising: an outer ring main body that is substantially cylindrical in shape; an antenna coupled to the outer ring main body, the antenna configured to transmit and receive wireless communications to or from a computing unit; and a housing unit coupled to the outer ring main body, the housing unit comprising: a microprocessor operating in conjunction with the antenna to transmit and receive the wireless communications to or from the computing unit; a computing memory operating in conjunction with the microprocessor; an electrical connector interface for coupling to a power source; and an inner connector configured to be placed inside the outer ring main body, the inner connector comprising: a lever; an upper plate attached to the lever; and a lower plate attached to the lever; where the lever is configured to move the upper plate in an upwards direction such that a gap is present between the upper plate and lower plate, and the lever is configured to move the upper plate in a downwards direction such that no gap is present between the upper plate and the lower plate.

Other features, examples, and embodiments are discussed further below.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 depicts an exemplary outer ring for a liquid flow control attachment that can be attached to a liquid dispensing unit.

FIG. 2 depicts an exemplary embodiment of an outer ring with threads on an interior surface of the outer ring.

FIG. 3 depicts an exemplary embodiment of an outer ring with a quick connect ring attachment.

FIG. 4 depicts an outer ring attached to an exemplary hose.

FIG. 5 depicts an exemplary embodiment of an inner connector.

FIG. 6 depicts a partial side view of another exemplary embodiment of an inner connector.

FIG. 7 depicts a further exemplary embodiment of an inner connector.

FIG. 8 depicts an exemplary rotating lever that can be utilized with an inner connector.

FIG. 9 depicts an exemplary liquid flow control attachment with an inner connector placed inside of an outer ring.

FIG. 10 depicts a diagrammatic representation of an example machine, or computing unit, in the form of a computer system.

### DETAILED DESCRIPTION

The present disclosure is now described more fully with reference to the accompanying drawings, in which example embodiments of the present disclosure are shown. The present disclosure may, however, be embodied in many different forms and should not be construed as necessarily being limited to the example embodiments set forth herein. Rather, these example embodiments are provided so that the disclosure is thorough and complete, and fully conveys the concepts of the present disclosure to those skilled in the art. Also, features described with respect to certain example embodiments may be combined in and/or with various other example embodiments. Different aspects and/or elements of example embodiments, as disclosed herein, may be combined in a similar manner. Further, at least some example embodiments may individually and/or collectively be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity, at least as described herein, in any manner, irrespective of the at least one entity have any relationship to the subject matter of the present disclosure.

Generally described, the present technology describes a liquid flow control attachment to a liquid dispensing unit, with a built-in wireless connection. The wireless connection allows for remote control of liquid flowing from the liquid dispensing unit. The attachment can be utilized on outdoor or indoor liquid dispensing units, such as faucets, hoses, plumbing pipes, tanks, etc. In exemplary embodiments, the attachment is used to remotely control a flow of water from a garden hose used to provide water to a plant, grass, swimming pool, or other rigid space that holds liquid. While the attachment is discussed herein in terms of controlling a water flow from a garden hose for simplicity, the attachment can similarly be used to control a flow of other types of liquid from other liquid dispensing units than a hose.

In various embodiments, the attachment comprises an outer ring that connects to a liquid dispensing unit, such as a hose, faucet, pipe, tank, etc. The attachment also comprises an optional inner connector that controls the flow of liquid from the liquid dispensing unit. The attachment further comprises a wireless communication capability to control a mechanical valve or other mechanism that allows for the flow of liquid from the liquid dispensing unit. These components are discussed in further detail herein.

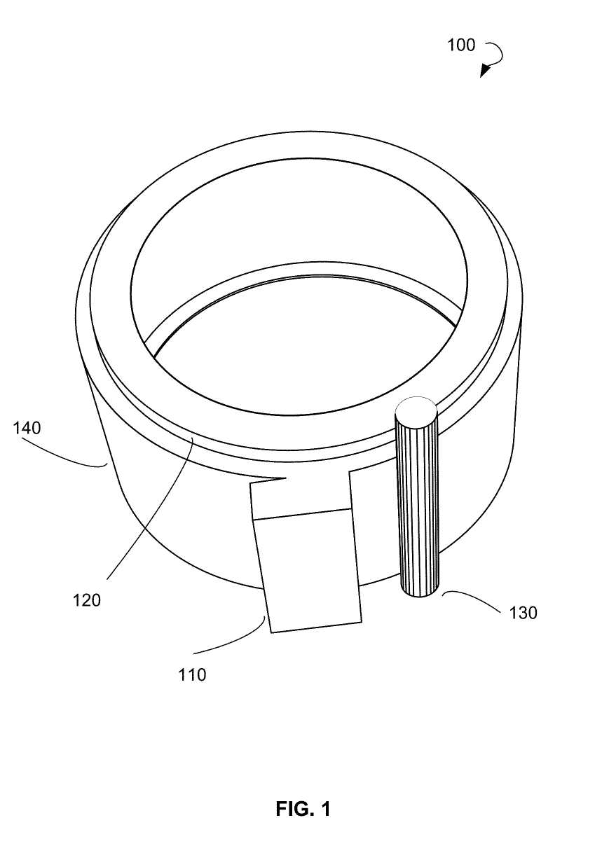

FIG. 1 depicts an exemplary outer ring 100 for a liquid flow control attachment that can be attached to a liquid dispensing unit, such as a hose. In various embodiments, the outer ring 100 is of a substantially cylindrical shape, to align with the shape of a terminal end of a hose, faucet, pipe, tank, etc. to which it is connected. The main body 140 of outer ring 100 can be one or more substantially cylindrical shapes that are attached to one another. In various embodiments, one or more components of outer ring 100 are constructed from waterproof materials typical of hose attachment accessories, such as plastic, BPA-free plastic, polymer, metal, stainless steel, aluminum, silicone, fiberglass, or combinations thereof. Outer ring 100 may additionally, or alternatively, be coated with a waterproof coating material.

Outer ring 100 contains a built-in wireless communication capability. In one embodiment, the wireless communication capability can be achieved via an antenna 130 attached to outer ring 100. While the antenna 130 is depicted in exemplary FIG. 1 as being attached to an outside edge of outer ring 100, a person of ordinary skill in the art would understand that antenna 130 can be attached to other locations of outer ring 100, in various embodiments. Further, antenna 130 can be of any other shape or size than the antenna depicted in exemplary FIG. 1.

Antenna 130 may be a multi-band antenna that is configured to send or receive communication signals from a number of different frequencies. Antenna 130 may also facilitate other types of wireless communications, such as Bluetooth, ZigBee, Wi-Fi, electromagnetic wave, RFID (radio frequency identification), etc. Antenna 130 may further connect to a microprocessor located within housing unit 110.

Housing unit 110 is depicted as a substantially box-type shape in exemplary FIG. 1. However, housing unit 110 may be of a different shape or size than that depicted in the figure, in various embodiments, including of a circular shape. Further, housing unit 110 may be located on a different part of outer ring 100 than the location depicted in the exemplary figure.

Housing unit 110 may contain at least one microprocessor, static or main memory, a network interface, at least one power source (such as a battery), and any other electrical components necessary for facilitating wireless communication capabilities. Housing unit 100 may also optionally contain a timer. The microprocessor enables control of at least one valve or other mechanical mechanism of a hose, to open the valve/mechanical mechanism and allow water to flow or to close the valve/mechanical mechanism to cease the flow of water. The valve/mechanical mechanism can also be partially opened or closed to increase or decrease an amount of water flowing through a hose.

The microprocessor can also operate in concert with a timer to automatically open/close a valve at a certain time, time of day, or upon the duration of a certain amount of time. Housing unit 110 may optionally contain at least one sensor for monitoring an environmental condition, such as temperature of air, temperature of water flowing through the hose, humidity level of air, air pressure, GPS coordinates, etc. The at least one sensor can operate in conjunction with the microprocessor and/or timer to program the hose to cease the flow of water from the hose if at least one condition is met, such as humidity level of air is at least at a certain threshold level (indicating a likely presence of rain). In other embodiments, an outside air temperature can be monitored such that water doesn't flow from the house if air temperature is below a threshold level (indicating a likelihood of water freezing), or if air temperature is above a certain threshold level (indicating a likelihood of a significant portion of the water simply evaporating into the air). As would be understood by persons of ordinary skill in the art, other types of sensors can be utilized to preset other types of conditions or triggers for opening or closing a valve on the house, to allow water to flow or to cease a flow of water.

In various embodiments, antenna 130 facilitates wireless communications between a microprocessor and a second computing device, such as a server computer. A human user may further interact with, and control certain operations of the microprocessor on the hose via a graphical user interface. The graphical user interface can be accessed by a human user via a web browser on a computing device, such as a desktop or laptop computer, netbook, smartphone, tablet, etc. A human user may further interact with, and control certain operations of the microprocessor on the hose via a dedicated software application on a smartphone, tablet, smartwatch, laptop or desktop computer, or any other computing device with a processor that is capable of wireless communication. In other embodiments, a human user can interact with, and control certain operations of the hose via a software application utilized by the user for controlling and monitoring other aspects of a residential or commercial building, such as a security system, home monitoring system for Internet-enabled appliances, voice assistant such as Amazon Echo, Google Home, etc.

Housing unit 110 may also comprise an electrical connector interface for electronically coupling a power source to, or for providing power/electricity to outer ring 100. Electrical connector interface may comprise, for example, an electrical cable (the electrical cable can be any of a charging cable, a FireWire cable, a USB cable, a micro-USB cable, a lightning cable, a retractable cable, a waterproof cable, a cable that is coated/covered with a material that would prevent an animal from chewing through to the electrical wiring, and combinations thereof), electrical ports (such as a USB port, micro-USB port, microSD port, etc.), a connector for batteries (including rechargeable battery, non-rechargeable battery, battery packs, external chargers, portable power banks, etc.), and any other standard power source used to provide electricity/power to household appliances and devices.

In various embodiments, at least one battery may be provided within housing unit instead of, or in addition to, an electrical connector interface. The battery may also have a wireless connection capability for wireless charging, or induction charging capabilities.

While not explicitly depicted in the figures, housing unit 110 may further consist of a cover that is easily opened and closed to reveal the components located inside. Further, housing 110 may optionally comprise a screen, such as an LCD screen, for viewing a current status. For example, the screen can depict information about water presently flowing through a house, such as flow rate, temperature, duration of water flow thus far, amount of time remaining before water flow is ceased, a status as to how much the valve is opened (fully opened, fully closed, or partially opened). In various embodiments, the screen may further depict any other status information such as battery power, amount of time until next water flow, any errors in operational status of components, etc. The screen is also waterproof to protect against any accidental spillage of water from the hose.

As discussed herein, outer ring 100 may connect with a liquid dispensing unit such as a hose, faucet, pipe, tank, etc. To facilitate connection with the liquid dispensing unit, outer ring 100 may have a connection ring 120. In an exemplary embodiment, connection ring 120 is a male connection for female threads that screw into an end of a hose, faucet, pipe, etc. In other embodiments, connection ring 120 may have female threads to align with a male connection on the end of a hose, faucet, pipe, etc.

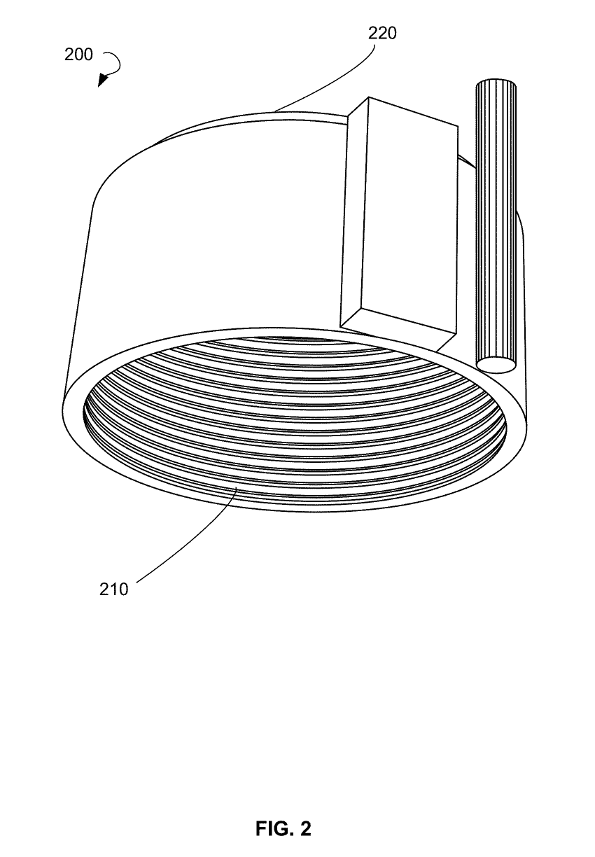

FIG. 2 depicts another exemplary embodiment of an outer ring 200, with threads located on an interior surface 210 of the outer ring 100, to screw into an end of a hose, faucet, pipe, etc., from which water flows. In various embodiments, outer ring 200 may also have an optional connection ring 220.

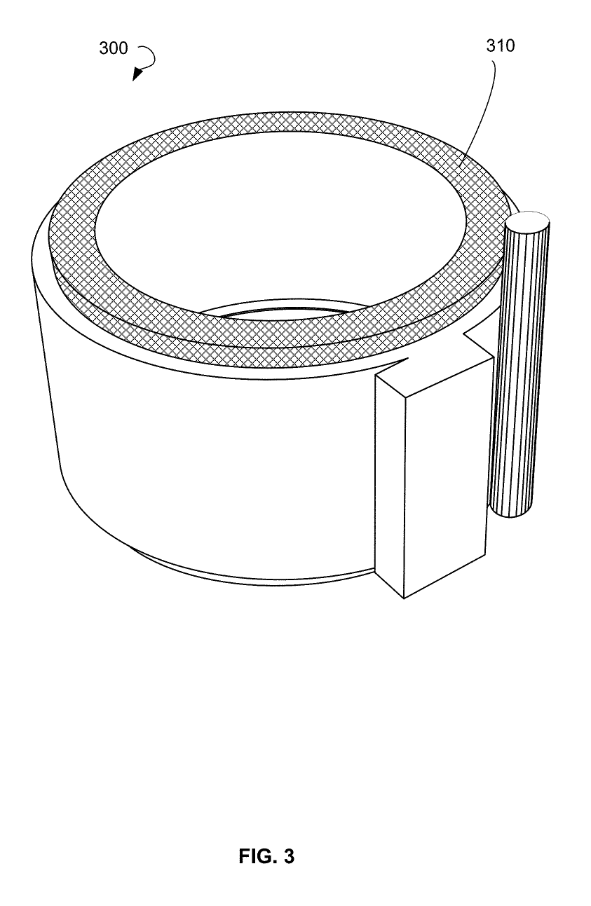

FIG. 3 depicts another exemplary embodiment of an outer ring 300, with a quick connect ring 310. The quick connect ring 310 enables connection of outer ring 300 to a liquid dispensing unit without the need for threads. The quick connect ring 310 essentially forms a watertight seal between outer ring 300 and the liquid dispensing unit without use of male and female connectors. While FIG. 3 depicts the quick connect ring 310 on a top edge of outer ring 300, the quick connect ring 310 may be on a bottom edge, or both top and bottom edges in various embodiments. Further, outer ring 300 may also have threads for screwing into a liquid dispensing unit, in addition to quick connect ring 310. This allows a human user to have a few different options for connecting outer ring to a liquid dispensing unit.

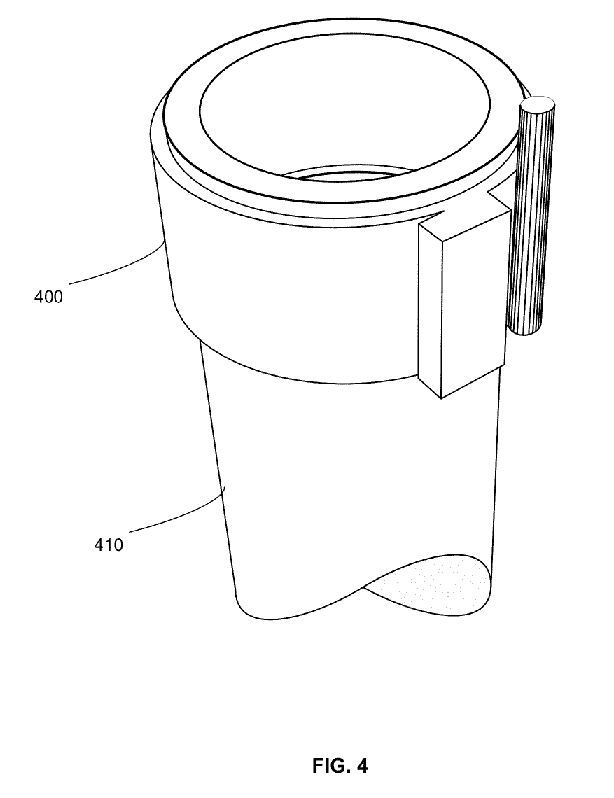

FIG. 4 depicts an outer ring 400 attached to an exemplary hose 410, as discussed herein. In an exemplary embodiment, hose 410 may be a garden hose of any size that is typically used in residences. For example hose 410 may range from ½ half to 2 inches in diameter.

In an exemplary use case for the attachment, a person can attach the liquid flow control attachment to a garden hose 410, and place the hose with the open end facing towards an interior of a swimming pool. A human user can utilize a software application running on a smartphone or tablet to detect that a water level of the swimming pool is lower than desired. This can be detected through cameras accessed through the software application, to view the water level of the swimming pool. Alternatively, a sensor can detect a water level of a swimming pool and relay that information to the human user via a software application.

The human user may then send a signal through the software application to turn on a valve for the hose such that water will flow through the hose into the swimming pool. The human user can either instruct the valve to be open for a certain amount of time, instruct the valve to fill the pool to a certain water level, or instruct the valve to keep filling water until further instruction. Subsequently, the user may determine, either through remote viewing of cameras, or through remote viewing of sensor data, that the swimming pool has enough water and send a signal wirelessly to the hose to turn off a valve for the hose and cease the flow of water into the pool.

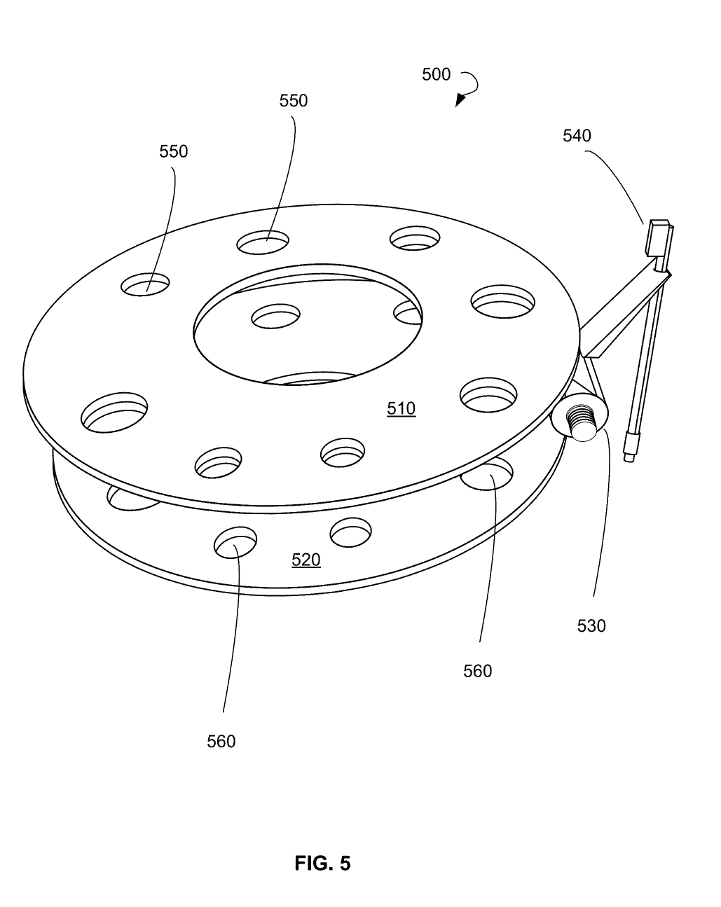

FIG. 5 depicts an exemplary embodiment of an inner connector 500 that can be utilized as a standalone mechanism, or with an outer ring, such as outer ring 410 of FIG. 4, to control a flow of liquid from a liquid dispensing unit, such as a flow of water from a hose. In various embodiments, inner connector 500 comprises an upper plate 510, a lower plate 520, a roller 530, and a lever 540. One or more of the components of inner connector 500 may be constructed from waterproof materials typical of hose attachment accessories, such as plastic, BPA-free plastic, polymer, metal, stainless steel, aluminum, silicone, fiberglass, or combinations thereof. One or more of the components of inner connector 500 may additionally, or alternatively, be coated with a waterproof coating material.

In some embodiments, there may be an open hole through the center of upper plate 510 and lower plate 520. The open hole reduces the pressure of liquid in the liquid dispensing unit. As would be understood by persons of ordinary skill in the art, the open hole through the center of upper plate 510 and lower plate 520 may be of a smaller or larger size than depicted in the exemplary figure. Additionally, the open hole may be of a different shape than circular, in various embodiments. Further, while not depicted in the figure, there may be no open hole through the center of upper plate 510 and/or lower plate 520, in other embodiments.

Lever 540 operates to move roller 530 that is between upper plate 510 and lower plate 520. When roller 530 is between upper plate 510 and lower plate 520, the two plates are separated and liquid can flow between them. Lever 540 can also move roller 530 to the side of the plates, such that lower plate 510 and upper plate 520 collapse onto one another.

In various embodiments, roller 530 may be omitted. Lever 540 may hold upper plate 510 off of lower plate 520 by means of a stationary support attached to lever 540. That is, lever 540 may be held in a stationary position by a support mechanism, such as by attaching lever 540 to a side of a liquid dispensing unit, or outer ring.

Upper plate 510 may also have a plurality of upper plate cutouts 550. While there are eight upper plate cutouts 550 depicted in exemplary FIG. 5, a person of ordinary skill in the art would understand that there can actually be more or less upper plate cutouts in various embodiments. Further, each of the upper plate cutouts 550 can be of varying shapes, sizes, and depths, or of the same shape, size, and/or depth. While circular cutouts are depicted in exemplary FIG. 5, other embodiments may have cutouts of a different shape or size.

Lower plate 520 may also have a plurality of lower plate cutouts 560. While there are six visible lower plate cutouts 560 depicted in exemplary FIG. 5, a person of ordinary skill in the art would understand that there can actually be more or less lower plate cutouts in various embodiments. Further, each of the upper plate cutouts 550 can be of varying shapes, sizes, and depths, or of the same shape, size, and/or depth. While circular cutouts are depicted in exemplary FIG. 5, other embodiments may have cutouts of a different shape or size.

In exemplary embodiments, some or all of upper plate cutouts 550 are solid indentions and not openings. That is, the cutout does not go entirely through a depth of upper plate 510. In this way, the upper plate cutout 550 is more like a cup-type structure, and not a cylindrical structure with a center opening. Thus, no liquid can flow through an upper plate cutout 550 that is a solid indention and not an opening. Lower plate cutouts 560 may be cutouts that go entirely through a depth of lower plate 520, or may also be solid indentions where the cutout only goes through a partial depth of lower plate 520. When roller 530 is removed and upper plate 510 collapses onto lower plate 520, upper plate cutouts 550 that are solid indentions align with lower plate cutouts 560, so that a water tight seal can be formed in the area of the cutouts. That is, no liquid can flow through the cutouts since the aligned cutouts are not open in a vertical direction. This allows for an efficient mechanism to cease a flow of liquid from a liquid dispensing unit.

In other embodiments, upper plate cutouts 550 may be fully open, while lower plate cutouts 560 are solid indentions and not openings. When the two plates collapse onto one another and the cutouts align, a water tight seal is formed in the area of the cutouts and no liquid can flow through the aligned cutouts since they are not open in a vertical direction.

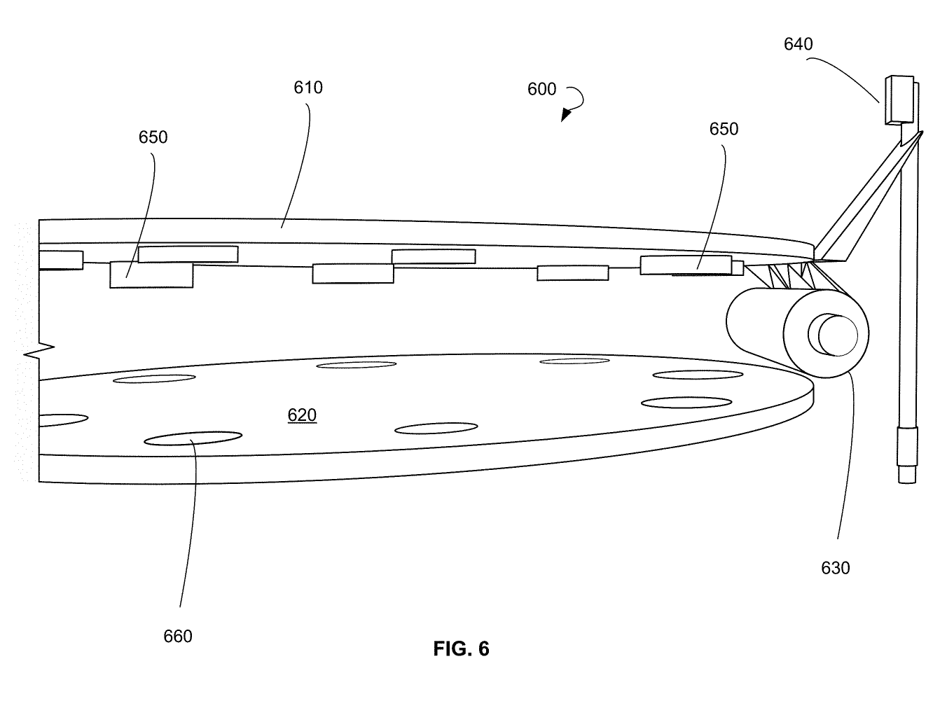

FIG. 6 depicts a partial side view of an exemplary embodiment of inner connector 600. In the exemplary figure, upper plate cutouts 650 are solid indentions that protrude below a bottom surface of upper plate 610. In other embodiments, upper plate cutouts 650 may be solid indentions that are flush with a bottom surface of upper plate 610. In FIG. 6, each of upper plate cutouts 650 is aligned with lower plate cutouts 660. When roller 630 is moved via lever 640, upper plate 610 collapses onto lower plate 620. The protruding ends of upper plate cutouts 650 fit into the open holes of lower plate cutouts 660. In this way, the two plates join together to form a water tight seal in the area of the cutouts. Further, the exemplary inner connector 600 does not have a center hole. Thus, when upper plate 610 and lower plate 620 collapse into one another, no liquid can flow through the inner connector 600 and out of the liquid dispensing unit.

In some embodiments, lever 540 and lever 640 can be manually controlled by a human user. In other embodiments, lever 540 and lever 640 can be remotely controlled via a communicably coupled microprocessor with wireless communication capability, as discussed herein. In this way, a person can remotely control liquid flow from a liquid dispensing unit through the inner connector.

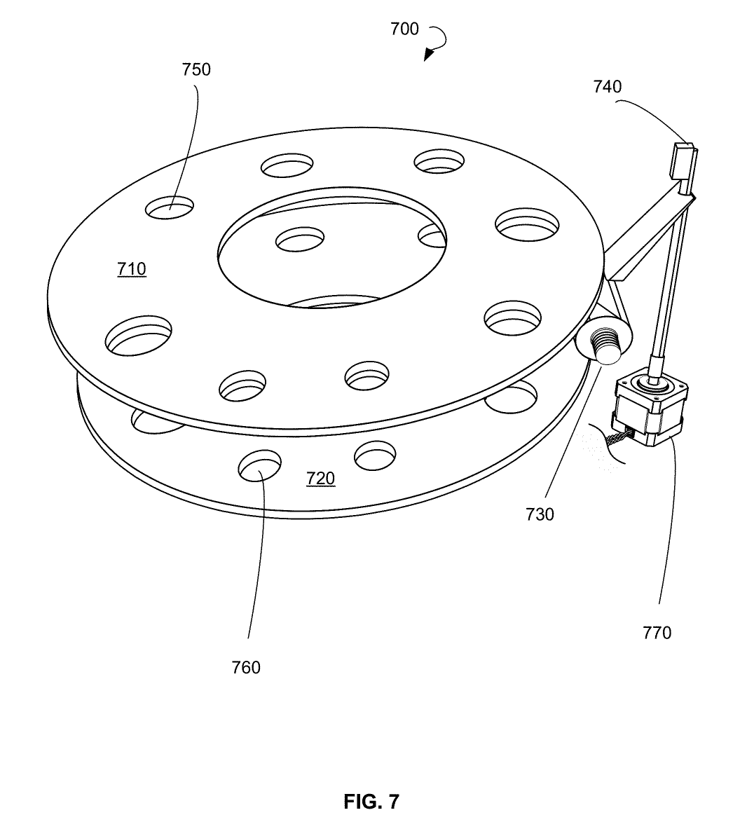

FIG. 7 depicts another exemplary embodiment of an inner connector 700 that can be utilized as a standalone mechanism, or with an outer ring (such as outer ring 410 of FIG. 4) to control a flow of liquid from a liquid dispensing unit, such as a flow of water from a hose. In various embodiments, inner connector 700 comprises an upper plate 710, a lower plate 720, a roller 730, a lever 740, upper plate cutouts 750, lower plate cutouts 760, and a motor 770. One or more of the components of inner connector 500 may be constructed from waterproof materials typical of hose attachment accessories, such as plastic, BPA-free plastic, polymer, metal, stainless steel, aluminum, silicone, fiberglass, or combinations thereof. One or more of the components of inner connector 500 may additionally, or alternatively, be coated with a waterproof coating material.

Inner connector 700 of FIG. 7 may be substantially similar to inner connector 500 of FIG. 5, with the exception of an additional motor. Motor 770 is merely an exemplary depiction, but may be a different type of motor than that depicted in the exemplary figure. Motor 770 may be a mechanical or self-motor that is utilized to move lever 740, resulting in the movement of roller 730. A housing for motor 770 (not depicted) may be connected to a wall of the liquid dispensing unit, such as an outer surface of a hose, or connected to an outer ring, such as outer ring 100 of FIG. 1.

In exemplary embodiments, roller 730 may be rolled off of the plates, such that upper plate 710 collapses onto lower plate 720. Further, upper plate cutouts 750 and lower plate cutouts 760 may align with one another and form a water tight seal, in various embodiments. In other embodiments, the center hole from upper plate 710 and/or lower plate 720 may be omitted such that when the two plates are collapsed, a full water tight seal forms. Thus, preventing the flow of any liquid from the liquid dispensing unit outwards from the inner connector 700.

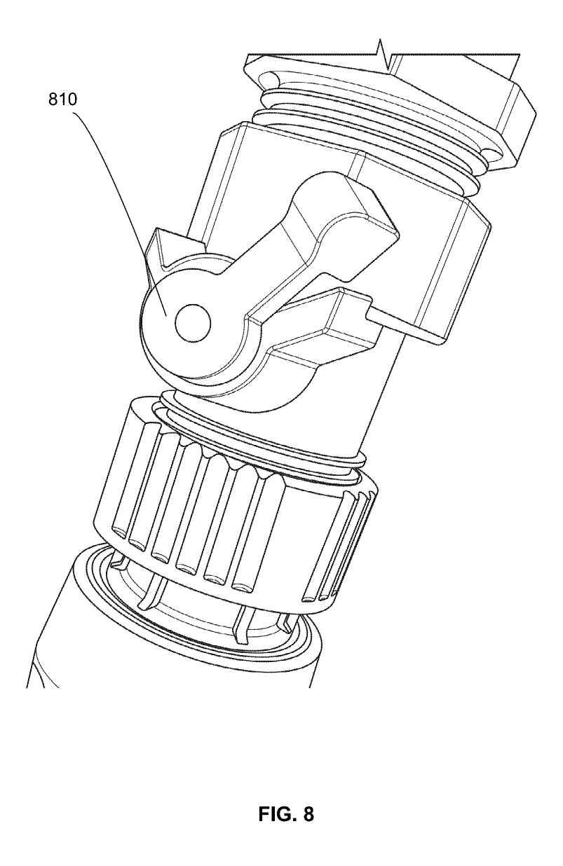

FIG. 8 depicts an exemplary rotating lever 810 that may be utilized with inner connectors, such as inner connector 500 of FIG. 5, inner connector 600 of FIG. 6, or inner connector 700 of FIG. 7. The rotating lever 810 may have a handle portion that moves an interior partition. Opening of the partition allows liquid to flow through, and closing the partition by rotating the lever blocks the flow of liquid. When closed, pressure from the liquid inside helps form a tight seal.

In some embodiments, rotating lever 810 can be manually controlled by a human user. In other embodiments, rotating lever 810 can be remotely controlled via a communicably coupled microprocessor with wireless communication capability, as discussed herein. In this way, a person can remotely control liquid flow from a liquid dispensing unit through the inner connector.

As described herein, outer ring (such as outer ring 100 of FIG. 1) can be used as a standalone liquid flow control attachment to a liquid dispensing unit. Wireless communication capability of the outer ring allow for the outer ring to control a flow of liquid from an attached liquid dispensing unit. In other embodiments, inner connector (such as inner connector 500 of FIG. 1) can also be used as a standalone attachment to a liquid dispensing unit. Inner connector can be attached to a terminal end of a liquid dispensing unit, or placed inside of a liquid dispensing unit, such as inside of a cross-section of a hose. Wireless communication capability of the inner connector allow for the inner connector to control a flow of liquid from an attached liquid dispensing unit.

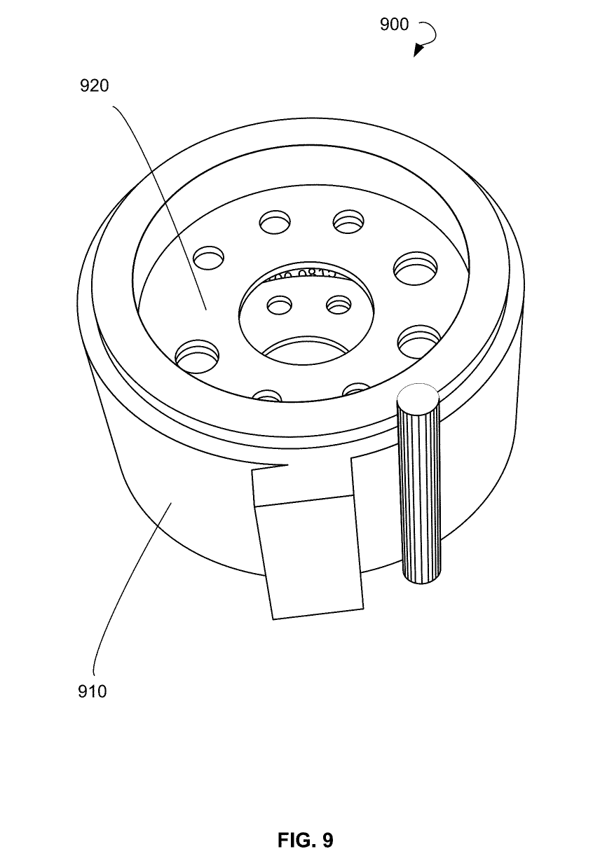

In further embodiments, an inner connector (such as inner connector 500 of FIG. 1) can be utilized in combination with an outer ring (such as outer ring 100 of FIG. 1). This exemplary embodiment is depicted in FIG. 9. In the exemplary embodiment, an inner connector 920 is placed inside of an outer ring 910. The entire liquid flow control attachment 900 is connected to a terminal end of a liquid dispensing unit, as discussed herein. Components of attachment 900 may be adjusted as discussed herein, either manually by a human user, or remotely via wireless communication, to enable, disable, or adjust a flow of liquid from liquid dispensing unit through attachment 900.

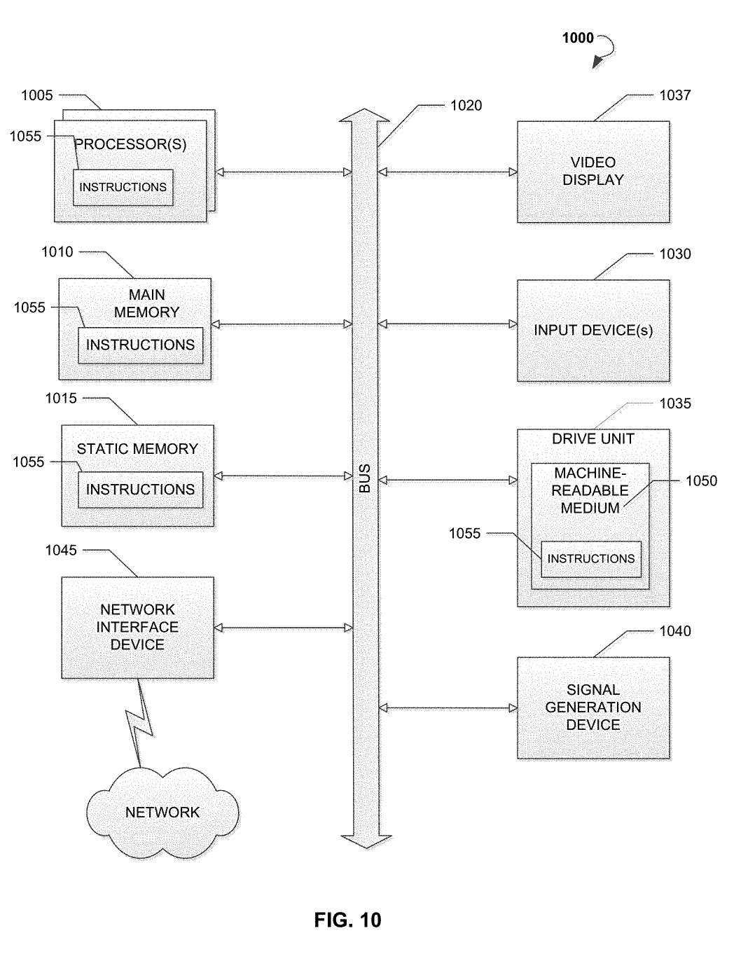

FIG. 10 is a diagrammatic representation of an example machine, or computing unit, in the form of a computer system 1000, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor or multiple processors 1005 (e.g., a central processing unit (CPU), a graphics processing unit (GPU), or both), and one or more of a main memory 1010 or static memory 1015, which communicate with each other via a bus 1020. The computer system 1000 may further include a video display 1037 (e.g., a liquid crystal display (LCD)). The computer system 1000 may also include an alpha-numeric input device(s) 1030 (e.g., a keyboard), a cursor control device (e.g., a mouse), a voice recognition or biometric verification unit (not shown), a drive unit 1035 (also referred to as disk drive unit), a signal generation device 1040 (e.g., a speaker), and a network interface device 1045. The computer system 1000 may further include a data encryption module (not shown) to encrypt data.

The drive unit 1035 includes a computer or machine-readable medium 1050 on which is stored one or more sets of instructions and data structures (e.g., instructions 1055) embodying or utilizing any one or more of the methodologies or functions described herein. The instructions 1055 may also reside, completely or at least partially, within the main memory 1010 and/or within the processors 1005 during execution thereof by the computer system 1000. The main memory 1010 and the processors 1005 may also constitute machine-readable media.

The instructions 1055 may further be transmitted or received over a network via the network interface device 1045 utilizing any one of a number of well-known transfer protocols (e.g., Hyper Text Transfer Protocol (HTTP)). While the machine-readable medium 1050 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computing products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the above description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), and a plural term may be indicated with or without an apostrophe (e.g., PE's or PEs). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/ or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A liquid flow control attachment apparatus configured to attach to a liquid dispensing unit and control a flow of liquid from the liquid dispensing unit, the liquid flow control attachment apparatus comprising:
an outer ring configured to attach to a terminal end of the liquid dispensing unit in a watertight manner, the outer ring further comprising:
an outer ring main body that is substantially cylindrical in shape;
an antenna coupled to the outer ring main body, the antenna configured to transmit and receive wireless communications to or from a computing unit; and
a housing unit coupled to the outer ring main body, the housing unit comprising:
a microprocessor operating in conjunction with the antenna to transmit and receive the wireless communications to or from the computing unit;
a computing memory operating in conjunction with the microprocessor; and
an electrical connector interface for coupling to a power source.

2. The liquid flow control attachment of claim 1, wherein the outer ring main body has at least one opening to allow liquid to flow through it.

3. The liquid flow control attachment of claim 1, wherein the antenna is configured to transmit and receive wireless communications via at least one of Bluetooth, Wi-Fi, RFID, or electromagnetic waves.

4. The liquid flow control attachment of claim 1, wherein the attached liquid dispensing unit is a garden hose.

5. The liquid flow control attachment of claim 1, further comprising a timer.

6. The liquid flow control attachment of claim 1, further comprising at least one sensor for monitoring an environmental condition within the liquid dispensing unit, or in an environment exterior to the liquid dispensing unit.

7. The liquid flow control attachment of claim 1, wherein the electrical connector interface couples to an electric charging cable.

8. The liquid flow control attachment of claim 1, wherein the electrical connector interface couples to a battery that provides power to the apparatus.

9. The liquid flow control attachment of claim 1, wherein a user remotely controls a flow of liquid from the liquid dispensing unit through the liquid flow control attachment via a software application transmitting wireless communications between the antenna and the computing unit.

10. A liquid flow control attachment apparatus configured to attach to a liquid dispensing unit and control a flow of liquid from the liquid dispensing unit, the liquid flow control attachment apparatus comprising:
an outer ring configured to attach to a terminal end of the liquid dispensing unit in a watertight manner, the outer ring further comprising:
an outer ring main body that is substantially cylindrical in shape;
an antenna coupled to the outer ring main body, the antenna configured to transmit and receive wireless communications to or from a computing unit; and
a housing unit coupled to the outer ring main body, the housing unit comprising:
a microprocessor operating in conjunction with the antenna to transmit and receive the wireless communications to or from the computing unit;
a computing memory operating in conjunction with the microprocessor; and
an electrical connector interface for coupling to a power source; and
an inner connector configured to be placed inside the outer ring main body, the inner connector comprising:
a lever;
an upper plate attached to the lever; and
a lower plate attached to the lever;
where the lever is configured to move the upper plate in an upwards direction such that a gap is present between the upper plate and lower plate, and the lever is configured to move the upper plate in a downwards direction such that no gap is present between the upper plate and the lower plate.

11. The liquid flow control attachment of claim 10, wherein the lower plate has a plurality of cutouts to allow liquid to flow through the liquid flow control attachment.

12. The liquid flow control attachment of claim 10, wherein a watertight seal is formed and no liquid flows through the liquid flow control attachment when no gap is present between the upper plate and the lower plate.

13. The liquid flow control attachment of claim 10, wherein the inner connector further comprises a roller between the upper plate and the lower plate, the roller moved by the lever to adjust any gap present between the upper plate and the lower plate.

14. The liquid flow control attachment of claim 10, wherein the inner connector further comprises a motor that drives the lever.

15. The liquid flow control attachment of claim 10, wherein the lever is a rotating lever.

16. The liquid flow control attachment of claim 10, wherein the upper plate and the lower plate each further comprise a center opening through which liquid can flow from the liquid dispensing unit through the liquid flow control attachment.

17. The liquid flow control attachment of claim 10, wherein a user remotely controls a flow of liquid from the liquid dispensing unit through the liquid flow control attachment via remote control of the lever with a software application transmitting wireless communications between the antenna and the computing unit.

18. The liquid flow control attachment of claim 1, wherein the electrical connector interface couples to an electric charging cable.

19. The liquid flow control attachment of claim 1, wherein the electrical connector interface couples to a battery that provides power to the apparatus.

20. A liquid flow control attachment apparatus configured to attach to a liquid dispensing unit and control a flow of liquid from the liquid dispensing unit, the liquid flow control attachment apparatus comprising:
an inner connector configured to be attached inside a liquid dispensing unit in a watertight manner, the inner connector comprising:
a lever;
an upper plate attached to the lever;
a lower plate attached to the lever;
where the lever is configured to move the upper plate in an upwards direction such that a gap is present between the upper plate and the lower plate, and the lever is configured to move the upper plate in a downwards direction such that no gap is present between the upper plate and the lower plate; and
a housing unit coupled to the lever, the housing unit comprising:
a microprocessor operating in conjunction with a network interface to transmit and receive the wireless communications to or from a computing unit;
a computing memory operating in conjunction with the microprocessor; and
an electrical connector interface for coupling to a power source.
